(19) United States
(12) Patent Application Publication
(10) Pub. No.: US 2014/0215156 A1
(43) Pub. Date: Jul. 31, 2014

(54) PRIORITIZED DUAL CACHING METHOD AND APPARATUS

(71) Applicant: ELECTRONICS AND TELECOMMUNICATIONS RESEARCH INSTITUTE, Daejeon (KR)

(72) Inventor: Jong Geun PARK, Daejeon (KR)

(73) Assignee: Electronics and Telecommunications Research Institute, Daejeon (KR)

(21) Appl. No.: 13/846,885

(22) Filed: Mar. 18, 2013

(30) Foreign Application Priority Data
Jan. 30, 2013 (KR) 10-2013-0010690

(51) Int. Cl. G06F 12/08

(52) U.S. Cl. CPC G06F 12/0802
USPC 711/119

(57) ABSTRACT

Provided are a prioritized dual caching method and apparatus. The dual caching apparatus includes a content cache unit configured to store a content cache separated into a first (premium) cache and a second (general) cache, a pointer storage unit configured to store a pointer for variably separating the first and second caches, a threshold value storage unit configured to store a first threshold value and a second threshold value that is less than the first threshold value, and a cache policy execution unit configured to receive a request for content, manage a request count value for the content, and execute a cache policy based on results of comparing the request count value to the first threshold value and the second threshold value and whether there is requested content in the content cache.

### CLAIM FOR PRIORITY

This application claims priority to Korean Patent Application No. 10-2013-0010690 filed on Jan. 30, 2013 in the Korean Intellectual Property Office (KIPO), the entire contents of which are hereby incorporated by reference.

### BACKGROUND

1. Technical Field

Example embodiments of the present invention relate in general to a caching method and apparatus and more specifically to a dual caching method and apparatus for improving the performance of caching and the quality of service by applying a caching policy differing according to popularity of content.

2. Related Art

In general, caching in a computer and a network system is technology that has long been used as means for improving the performance of a system and service. Almost all systems such as a central processing unit (CPU), a file system, a database system, a web server, a web browser, and a content server are providing optimum services by applying various caching methods.

In general, the performance of a cache system can be improved by improving an algorithm. This has a more excellent effect than when a cache capacity is increased. Accordingly, many researchers are continuing various research activities so as to improve the performance of caching algorithms.

In addition to a least recently used (LRU) method serving as the most widely used caching method, various caching algorithms developed long ago, such as least frequently used (LFU), first in first out (FIFO), last in first out (LIFO), round robin (RR), and random selection (RS) algorithms, are being applied.

However, the LRU algorithm is substantially the most widely utilized because the algorithm is simple and a cache hit ratio, which is a measure of efficiency of caching, is not very low.

Although the LRU algorithm is the most widely used, a further optimized algorithm is required according to an attribute of an actual system and various derivative algorithms reflecting a system attribute are being steadily developed. As representative examples, algorithms such as least k^{th}-to-last reference (LRU-K), two queue (2Q), least recently frequently used (LRFU), and adaptive replacement cache (ARC) algorithms have been developed. Various new derivative algorithms have been developed for a web server or proxy due to activation of Internet services.

According to previous research results, the popularity of web content is known to conform to Zipf's distribution. That is, while some very popular content is very frequently accessed, a large number of pieces of content are not frequently accessed. Accordingly, if a caching algorithm appropriately utilizing the attribute of Zipf's distribution is applied, it is possible to obtain a better performance result than when an existing algorithm is applied in a web system.

However, because a peer-to-peer (P2P) system or the like has a characteristic that one user generally accesses and uses the same content once, a popularity characteristic different from that of the existing web content conforms to Mandelbrot-Zipf's distribution as studied. That is, because the maximum number of uses does not generally exceed the number of users in some content having high popularity, the maximum number of uses of content is generally predictable.

### SUMMARY

Accordingly, example embodiments of the present invention are provided to substantially obviate one or more problems due to limitations and disadvantages of the related art.

Example embodiments of the present invention provide a dual caching method of operating a dynamic content caching policy according to popularity of content.

Example embodiments of the present invention provide a dual caching apparatus for operating a dynamic content caching policy according to popularity of content.

Example embodiments of the present invention provide a content server for operating a dynamic content caching policy according to popularity of content.

In some example embodiments, a dual caching method using a content cache separated into a first (premium) cache and a second (general) cache, includes: receiving a request for content; performing a counting operation of incrementing a request count value for requested content; making a cache hit determination by determining whether there is the requested content in the content cache; and executing a first policy of determining whether to delete the requested content from the content cache by comparing the request count value to a first threshold value when there is the requested content in the content cache and determining one of the first and second caches in which the requested content is positioned by comparing the request count value to a predetermined second threshold value, which is less than the first threshold value.

In the dual caching method, the content cache may be separated into the first and second caches so that each of the first and second caches has a variable size by a pointer.

In the dual caching method, the executing of the first policy may include: deleting the requested content from the content cache when the request count value is greater than or equal to the first threshold value.

In the dual caching method, the executing of the first policy may include: positioning the requested content in the first cache when the request count value is less than the first threshold value and greater than or equal to the second threshold value; and positioning the requested content in the second cache when the request count value is less than the second threshold value.

The dual caching method may further include: executing a second policy of determining whether the content cache state is a full state based on a comparison result between the request count value and the first threshold value when there is no requested content in the content cache and determining a cache replacement or determining whether to load the requested content to the cache based on a state of the second cache.

At this time, the executing of the second policy may include: preventing the requested content from being loaded to the cache when the request count value is greater than or equal to the first threshold value.

At this time, when the request count value is less than the first threshold value and a content cache state is not a full state, the executing of the second policy may include: positioning the requested content in the first cache when the request count value is greater than or equal to the second threshold value; and positioning the requested content in the second cache when the request count value is less than the second threshold value.

At this time, when the request count value is less than the first threshold value and the content cache state is a full state, the executing of the second policy may include: deleting at least some content of the second cache when the second cache is not empty; and deleting at least some content of the first cache when the second cache is empty. At this time, after at least some content of the first or second cache is deleted, the executing of the second policy may include: positioning the requested content in the first cache when the request count value is greater than or equal to the second threshold value; and positioning the requested content in the second cache when the request count value is less than the second threshold value.

In other example embodiments, a dual caching apparatus includes: a content cache unit configured to store a content cache separated into a first (premium) cache and a second (general) cache; a pointer storage unit configured to store a pointer for variably separating the first and second caches; a threshold value storage unit configured to store a first threshold value and a second threshold value that is less than the first threshold value; and a cache policy execution unit configured to receive a request for content, manage a request count value for the content, and execute a cache policy based on results of comparing the request count value to the first threshold value and the second threshold value and whether there is requested content in the content cache.

In the dual caching apparatus, the cache policy execution unit may determine whether to delete the requested content from the content cache by comparing the request count value to the first threshold value when there is the requested content in the content cache and determine one of the first and second caches in which the requested content is positioned by comparing the request count value to the second threshold value, which is less than the first threshold value.

At this time, the cache policy execution unit may send a response for the request for the content and delete the requested content from the cache when the request count value is greater than or equal to the first threshold value.

At this time, the cache policy execution unit may position the requested content in the first cache when the request count value is less than the first threshold value and greater than or equal to the second threshold value, and position the requested content in the second cache when the request count value is less than the second threshold value.

In the dual caching apparatus, the cache policy execution unit may determine a cache replacement or determine whether to load the requested cache to the cache based on a comparison result between the request count value and the first threshold value, a state of the content cache, and a state of the second cache when there is no requested content in the content cache.

At this time, the cache policy execution unit may prevent the requested content from being loaded to the cache when the request count value is greater than or equal to the first threshold value.

At this time, when the request count value is less than the first threshold value and a content cache state is not a full state, the cache policy execution unit may position the requested content in the first cache when the request count value is greater than or equal to the second threshold value, and position the requested content in the second cache when the request count value is less than the second threshold value.

At this time, when the request count value is less than the first threshold value and the content cache state is a full state, the cache policy execution unit may delete at least some content of the second cache when the second cache is not empty, and delete at least some content of the first cache when the second cache is empty. At this time, the cache policy execution unit may position the requested content in the first cache when the request count value is greater than or equal to the second threshold value after at least some content of the first or second cache is deleted, and position the requested content in the second cache when the request count value is less than the second threshold value.

In still other example embodiments, a content server for executing a dual cache policy, includes: a dual caching apparatus including a content cache unit configured to store a content cache separated into a first (premium) cache and a second (general) cache; a pointer storage unit configured to store a pointer for variably separating the first and second caches; a threshold value storage unit configured to store a first threshold value and a second threshold value that is less than the first threshold value; and a cache policy execution unit configured to receive a request for content, manage a request count value for the content, and execute a cache policy based on results of comparing the request count value to the first threshold value and the second threshold value and whether there is requested content in the content cache.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a concept of a dual cache in accordance with an example embodiment of the present invention;

FIG. 2 is a block diagram illustrating a configuration of a dual caching apparatus in accordance with an example embodiment of the present invention;

FIG. 3 is a conceptual diagram illustrating an application environment of the dual caching apparatus in accordance with an example embodiment of the present invention;

FIG. 4 is a flowchart illustrating a dual caching method in accordance with an example embodiment of the present invention; and

FIG. 5 is a flowchart illustrating the step of executing an additional cache policy in the dual caching method in accordance with an example embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein. Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, preferred embodiments of the present invention will be described in more detail with reference to the accompanying drawings.

### Configuration of Dual Cache in Accordance with Example Embodiment of Present Invention

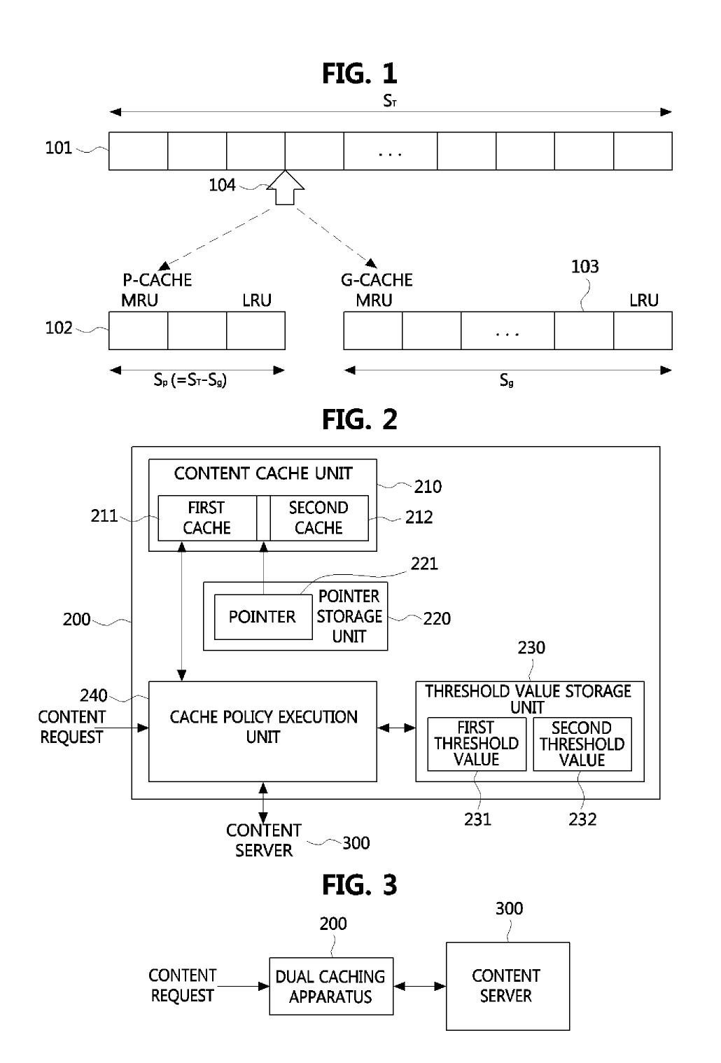

FIG. 1 is a conceptual diagram illustrating a concept of the dual cache in accordance with the example embodiment of the present invention.

Referring to FIG. 1, the dual cache in accordance with the example embodiment of the present invention serving as a basis of a dual caching method and apparatus in accordance with an example embodiment of the present invention can be implemented by a content cache 101 and a dual cache pointer 104 for dualistically dividing the content cache 101.

In general, the content cache 101 in a content server or proxy is more expensive than a storage medium such as a normal hard disk drive (HDD) storing content, but is implemented using a high-speed storage medium and has a relatively small space.

In the dual caching method in accordance with an example embodiment of the present invention, when a size of a storage space used as the content cache 101 is S_{T}, one cache space logically operates like two caches 102 and 103 using the dual cache pointer 104.

The two caches 103 and 102 can be configured as a general cache (hereinafter referred to as “g-cache”) 103 capable of applying a normal cache policy and a premium cache (hereinafter referred to as “p-cache”) 102 capable of separately storing content regarded to be popular content when popularity is determined to be at a fixed level or more and applying a cache policy different from the existing cache policy.

Sizes Sₚ and S_{g} of the two caches 102 and 103 are dynamically varied according to popularity of content in service in a system and a use pattern of users. As described above, in order to manage two dynamic and logical caches in one cache system, the dual cache pointer 104 can be provided and one cache 101 in the system can operate like the two caches 102 and 103 using the dual cache pointer 104.

Further, because the sizes Sₚ and S_{g} of the two caches 102 and 103 are dynamically varied according to the popularity of content in service in the system and the use pattern of the user, the size of any one cache 102 or 103 can be 0 and any one cache 102 or 103 can occupy the entire cache 101.

In addition, the two logically partitioned caches 102 and 103 can be subjected to independent caching policies or can be equally subjected to the most widely used LRU caching algorithm. For example, when the LRU caching algorithm is equally applied, the two caches 102 and 103 are not affected by each other. Content ranging from content corresponding to most recently used (MRU) content with highest priority to content corresponding to LRU content with lowest priority is constantly present in each cache. If only one piece of content is cached in an arbitrary cache, this content serves as the MRU content and the LRU content. The priority of content within the two logical caches may differ according to an applied caching algorithm.

### Dual Caching Apparatus in Accordance with Example Embodiment of Present Invention

FIG. 2 is a block diagram illustrating the configuration of the dual caching apparatus in accordance with the example embodiment of the present invention.

Referring to FIG. 2, an example of the dual caching apparatus 200 in accordance with the example embodiment of the present invention can include a content cache unit 210, a pointer storage unit 220, a threshold value storage unit 230, and a cache policy execution unit 240.

First, the content cache unit 210 is a component storing a content cache separated into a first cache (premium cache 211) and a second cache (general cache 212). The first and second caches can correspond respectively to the p-cache 102 and the g-cache 103 described with reference to FIG. 1.

In general, the content cache unit 210 can be implemented using a high-speed memory device having a fast access speed and a fast read/write speed. As described above, the content cache is more expensive than a storage medium such as a normal HDD storing content, but can have a relatively small space as a high-speed storage space. For example, the content cache unit 210 can be implemented using a high-speed solid state disk (SSD) or a high-speed memory device.

Next, the pointer storage unit 220 is a component storing a pointer 221 for variably separating the first and second caches so that each of the first cache 211 and the second cache 212 stored in the content cache unit 210 has a variable size.

The pointer storage unit 220 can be implemented using a register constituted of a predetermined number of bits capable of storing the pointer or the like. However, the pointer storage unit 220 can be implemented using a partial memory space of a memory device in which program codes implementing an operation of the cache policy execution unit 240 (the dual caching method in accordance with the example embodiment of the present invention) are executed along with the threshold value storage unit 230 as will be described later. In addition, the pointer storage unit 220 can be implemented using a partial space of the content cache unit 210 along with the threshold value storage unit 230 as will be described later.

Next, the threshold value storage unit 230 is a component storing a first threshold value 231 and a second threshold value 232. A form in which the threshold value storage unit 230 is implemented may be similar to a form in which the above-described pointer storage unit 220 is implemented.

The first threshold value 231 and the second threshold value 232 are threshold values for executing cache policies necessary for the cache policy execution unit 240 to perform the dual caching method in accordance with an example embodiment of the present invention. The first threshold value 231 and the second threshold value 232 may be preset by the user, and may be variably varied while the content server is in operation.

The first threshold value 231 can be determined based on the total number of users using the content server. Also, the first threshold value 231 can be determined based on the number of content-specific users of the content server. At this time, a predicted value can be applied as the total number of users serving as a basis for determining the first threshold value. A meaning and role of the first threshold value 231 will be described later. On the other hand, the second threshold value 232 is a threshold value used to determine one of the first cache 211 and the second cache 212 in which requested content is positioned as a smaller threshold value than the first threshold value. A meaning and role of the second threshold value 232 will be described later.

Finally, the cache policy execution unit 240 is a component that receives a content request from the user (the client terminal or the like), manages a request count value for the content, and executes a cache policy based on results of comparing the request count value to the first threshold value 231 and the second threshold value 232 and whether there is requested content within the content cache.

The cache policy execution unit can be implemented as a dedicated controller, and can be implemented using a general-purpose microprocessor, program codes executable by the microprocessor, and a memory device configured to load the program codes and provide an operation environment of the microprocessor. A specific operation of the cache policy execution unit 240 will be described in detail in the description of the dual caching method in the example embodiment of the present invention as will be described later.

FIG. 3 is a conceptual diagram illustrating an application environment of the dual caching apparatus in accordance with an example embodiment of the present invention.

Referring to FIG. 3, the dual caching apparatus 200 in accordance with the example embodiment of the present invention first receives a user request for content stored in a content server 300. That is, when the content requested through the user request is stored in the content cache unit of the dual caching apparatus (a cache hit), the content stored in the cache unit is provided to the user. Otherwise (a cache miss), the content is provided to the user from the content server 300 instead of the cache.

Although the dual caching apparatus 200 located outside the content server 300 is illustrated in FIG. 3, the dual caching apparatus 200 can actually be implemented inside the content server without being implemented as an apparatus physically separated from the content server 300.

In general, the dual caching apparatus in accordance with the example embodiment of the present invention can be implemented using a memory accessible by the content cache unit 210 included in the dual caching apparatus at a high speed. The dual caching method in accordance with the example embodiment of the present invention as will be described later can be performed by a dedicated controller or a general-purpose microprocessor.

In any case, the content server 300 can be implemented to include the dual caching apparatus 200 in accordance with the example embodiment of the present invention. Alternatively, the dual caching apparatus 200 and the content server 300 can be implemented as separate apparatuses.

### Dual Caching Method in Accordance with Example Embodiment of Present Invention

Hereinafter, a configuration of the dual caching method in accordance with the example embodiment of the present invention will be described in detail.

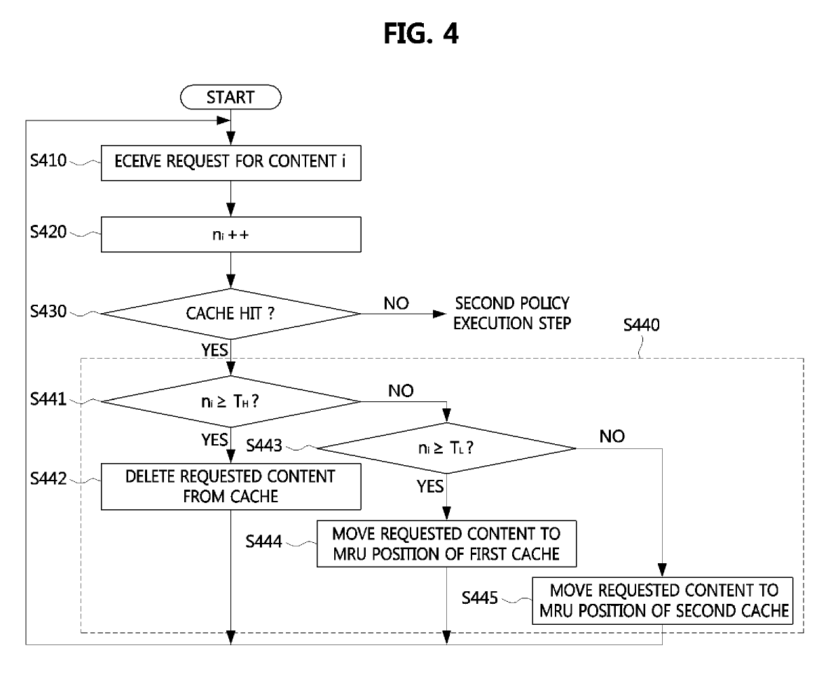

FIG. 4 is a flowchart illustrating the dual caching method in accordance with the example embodiment of the present invention.

Referring to FIG. 4, the dual caching method in accordance with the example embodiment of the present invention can include a content request reception step S410, step S420 of performing a counting operation by incrementing a request count value, a cache hit determination step S430, and step S440 of executing a first policy when there is a cache hit.

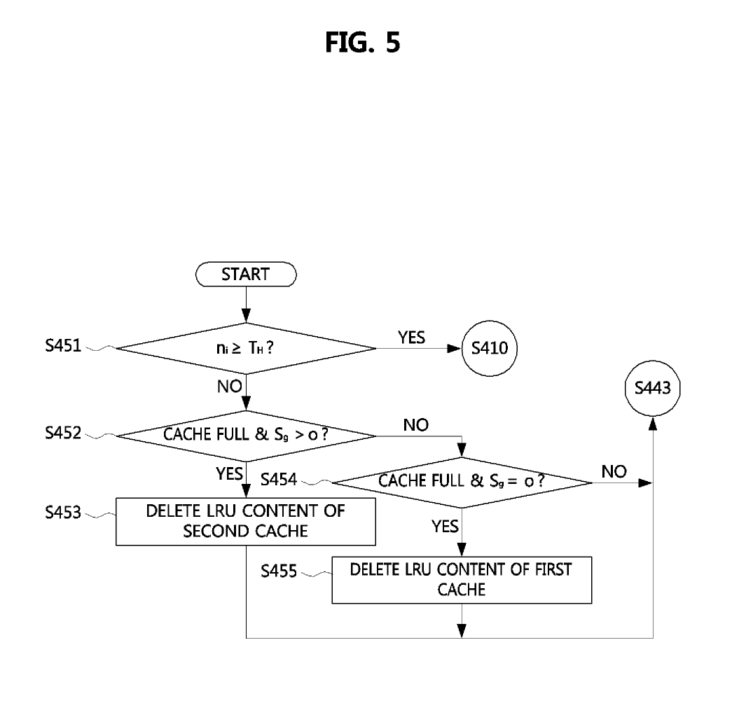

Additionally, the dual caching method in accordance with the example embodiment of the present invention can further include a second policy execution step to be performed when there is no cache hit. The second policy execution step will be described later with reference to FIG. 5.

First, the content request reception step S410 is the step of receiving the request for content from the user (for example, the client terminal). For example, the dual caching apparatus in accordance with the example embodiment of the present invention is provided inside or outside the content server, and first receives the request for content transmitted to the content server. When the requested content is stored in the cache (a cache hit), the content is provided from the cache to the user. Otherwise (a cache miss), the content is provided to the user from the content server instead of the cache. This is the same as described with reference to FIG. 3.

Next, the counting step S420 is the step of incrementing the request count value for the requested content. That is, when a request for certain content i is received in the dual caching method in accordance with the example embodiment of the present invention, the number of uses of the content (popularity nᵢ) is incremented by 1. Through this, it is possible to execute a differential cache policy (an operation of determining which content is stored in which cache) for content having high popularity (a large number of uses) among users in the dual caching method in accordance with the example embodiment of the present invention.

Next, in the cache hit determination step S430, it is determined whether the content requested in step S410 is stored in the content cache.

When the requested content is determined to have been stored in the content cache (that is, a cache hit situation) in the cache hit determination step S430, the first policy execution step S440 is performed. When the requested content is determined not to have been stored in the content cache (that is, a cache miss situation) in the cache hit determination step S430, the second policy execution step (described with reference to FIG. 5) is performed.

Next, the first policy execution step S440 is the step of determining whether to delete the requested content from the content cache by comparing the request count value to the first threshold value when the requested content is stored in the content cache, and determining one of the first and second caches in which the requested content is positioned by comparing the request count value to the predetermined second threshold value, which is less than the first threshold value.

For this, it is determined whether the total number of uses of the requested content is greater than or equal to a preset first threshold value T_{H} in the first policy execution step (S441).

At this time, the first threshold value (upper threshold value T_{H}) can be determined based on the total number of users. For example, the first threshold value may be a value less than the total number of users. Because content of which the number of uses is greater than or equal to the first threshold value has been sufficiently and frequently used, the first threshold value becomes a reference value for determining a policy of deleting the content from a caching target by determining a caching effect to be relatively small. Thus, although relative loss in which the caching effect is not obtained occurs when a request for content is generated after a point in time at which the number of uses has exceeded the upper threshold value, it is possible to increase the caching effect in view of the entire system by caching content to be frequently used in the future according to characteristics of a cache having a limited capacity.

Because the effect of caching the content is relatively small when the number of uses of the requested content is greater than or equal to the first threshold value T_{H}, the requested content is deleted from the cache (S442), and the process returns to step S410 of receiving the next content request.

When the number of uses of the requested content is still determined to be less than the first threshold value, it is determined whether the number of uses of the requested content is greater than or equal to the second threshold value T_{L} (S443).

Here, the second threshold value T_{L} is a lower threshold value that is less than the first threshold value T_{H}. Because content of which the number of uses is greater than or equal to the second threshold value T_{L} is content determined to have popularity of a fixed level or more and predicted to have relatively high popularity in the future, the second threshold value T_{L} becomes a reference value that determines a policy for relatively increasing a cache hit ratio by storing the content in the cache for a relatively long time.

Thus, priority is assigned to content of which the number of uses has exceeded the second threshold value T_{L} and the content with the priority is cached, so that it is possible to have the effect of maximizing expected performance by differently applying the caching policy to the limited cache space according to popularity. That is, in accordance with the present invention, a cache space to store content of which the number of uses is greater than or equal to the second threshold value is the first cache (p-cache 211). In addition, content of which the number of uses is less than the second threshold value is stored in the second cache (g-cache 212), which is a general cache space.

Accordingly, when the number of uses of the requested content is less than the upper threshold value and greater than or equal to the lower threshold value, the requested content already stored in the second cache 212 is moved to the first cache 211 and assigned high priority (S444), and then the next content request is awaited (S410).

The case in which the first cache 211 and the second cache 212, which are logically separated, are managed by independent LRU algorithms will be assumed and described in the example embodiment of the present invention. Accordingly, content with highest priority inside the first cache 211 and the second cache 212 is MRU content. Finally, because the content is managed in the general second cache 212 if the number of uses of the requested content is less than the second threshold value, the content is assigned highest priority in the second cache 212 (S445) and then the next content request is awaited (S410).

FIG. 5 is a flowchart illustrating the step of executing an additional cache policy in the dual caching method in accordance with an example embodiment of the present invention.

FIG. 5 is a diagram illustrating the second policy execution step. The second policy execution step is started when there is no requested content in the content cache (that is, a cache miss situation) in the above-described step S430.

That is, the second policy execution step is the step of determining whether the content cache state is a full state based on a comparison result between the request count value and the first threshold value when there is no requested content in the content cache and determining a cache replacement or determining whether to load the requested content to the cache based on a state of the second cache.

When the requested content is determined to be absent in the cache (that is, the cache miss situation) in the above-described step S430, it is first determined whether the total number of uses of the requested content is greater than or equal to the preset first threshold value T_{H} (S451).

At this time, because the content is determined to have been sufficiently and frequently used as described above when the number of uses of the requested content is greater than or equal to the first threshold value, the content is excluded from the caching target. Hence, in a state in which no action is taken, the process proceeds to step S410 of receiving the next content request. That is, in this case, the content server can directly process the content request from the user.

Because the content is an application target of the caching policy if the number of uses of the requested content is less than the upper threshold value, the content is immediately cached when there is free space in the cache. Otherwise, a cache replacement policy should be applied to delete one of pieces of existing cached content or delete one or more pieces of content according to a size of content if necessary.

First, it is determined whether one or more pieces of content are stored in the second cache (that is, S_{g}>0) while the cache is already full or free space is insufficient to cache the requested content (S452). If so, a space to cache the requested content should be first secured by deleting some content stored in the second cache 212 rather than the first cache 211 having relatively high priority. At this time, low-priority content of the second cache 212 (LRU content in the LRU algorithm) can be configured to be deleted from the cache (S453).

Because it is necessary to secure free space in the cache, it is determined whether there is no content stored in the second cache 212 (that is, S_{g}=0) (S454). If so (that is, when the entire cache operates as only the first cache 211), a minimum space should be secured to cache the requested content by deleting at least some content form the first cache 211 having priority for caching (S455). Even in this case, low-priority content of the first cache 211 (LRU content in the LRU algorithm) can be configured to be deleted from the cache (S455).

On the other hand, when the cache has enough free space to cache the requested content, or after such a caching space is secured through the above-described replacement policy (S453 and S455), the process proceeds to step S443 of the above-described first policy execution step. That is, after it is determined whether the requested content is content to be stored in the first cache 211 or content to be stored in the g-cache 212, the content is cached according to the determination result and then a series of processes of receiving a content request is iteratively applied.

As described above, one physical cache is separated into two different logical caches according to the caching policy. Caching policies independent of each other are applied. A size of each of the two logical caches is dynamically adjusted according to a use pattern or popularity of content or the like.

According to the configuration in accordance with the example embodiment of the present invention, it is possible to ensure a higher cache hit ratio than in the related art using a cache of the same capacity by separating one cache into two logical caches having different priorities according to a use pattern such as the number of uses or popularity of content in a content use environment in which the maximum number of uses of popular content does not substantially exceed the total number of users as in a P2P system or the like.

That is, when content is provided to a user in a computer and a network system in accordance with the example embodiment of the present invention, it is possible to reduce a network traffic load and deliver the content to the user in a shorter time.

While the example embodiments of the present invention and their advantages have been described in detail, it should be understood that various changes, substitutions and alterations may be made herein without departing from the scope of the invention.

What is claimed is:

1. A dual caching method using a content cache separated into a first (premium) cache and a second (general) cache, comprising:
receiving a request for content;
performing a counting operation of incrementing a request count value for requested content;
making a cache hit determination by determining whether there is the requested content in the content cache; and
executing a first policy of determining whether to delete the requested content from the content cache by comparing the request count value to a first threshold value when there is the requested content in the content cache and determining one of the first and second caches in which the requested content is positioned by comparing the request count value to a predetermined second threshold value, which is less than the first threshold value.

2. The dual caching method of claim 1, wherein the content cache is separated into the first and second caches so that each of the first and second caches has a variable size by a pointer.

3. The dual caching method of claim 1, wherein the executing of the first policy includes:
deleting the requested content from the content cache when the request count value is greater than or equal to the first threshold value.

4. The dual caching method of claim 1, wherein the executing of the first policy includes:
positioning the requested content in the first cache when the request count value is less than the first threshold value and greater than or equal to the second threshold value; and
positioning the requested content in the second cache when the request count value is less than the second threshold value.

5. The dual caching method of claim 1, further comprising:
executing a second policy of determining whether the content cache state is a full state based on a comparison result between the request count value and the first threshold value when there is no requested content in the content cache and determining a cache replacement or determining whether to load the requested content to the cache based on a state of the second cache.

6. The dual caching method of claim 5, wherein the executing of the second policy includes:
preventing the requested content from being loaded to the cache when the request count value is greater than or equal to the first threshold value.

7. The dual caching method of claim 5, wherein, when the request count value is less than the first threshold value and a content cache state is not a full state, the executing of the second policy includes:
positioning the requested content in the first cache when the request count value is greater than or equal to the second threshold value; and
positioning the requested content in the second cache when the request count value is less than the second threshold value.

8. The dual caching method of claim 5, wherein, when the request count value is less than the first threshold value and the content cache state is a full state, the executing of the second policy includes:
deleting at least some content of the second cache when the second cache is not empty; and
deleting at least some content of the first cache when the second cache is empty.

9. The dual caching method of claim 8, wherein, after at least some content of the first or second cache is deleted, the executing of the second policy includes:
positioning the requested content in the first cache when the request count value is greater than or equal to the second threshold value, and
positioning the requested content in the second cache when the request count value is less than the second threshold value.

10. A dual caching apparatus comprising:
a content cache unit configured to store a content cache separated into a first (premium) cache and a second (general) cache;
a pointer storage unit configured to store a pointer for variably separating the first and second caches;
a threshold value storage unit configured to store a first threshold value and a second threshold value that is less than the first threshold value; and
a cache policy execution unit configured to receive a request for content, manage a request count value for the content, and execute a cache policy based on results of comparing the request count value to the first threshold value and the second threshold value and whether there is requested content in the content cache.

11. The dual caching apparatus of claim 10, wherein the cache policy execution unit determines whether to delete the requested content from the content cache by comparing the request count value to the first threshold value when there is the requested content in the content cache and determines one of the first and second caches in which the requested content is positioned by comparing the request count value to the second threshold value, which is less than the first threshold value.

12. The dual caching apparatus of claim 11, wherein the cache policy execution unit sends a response for the request for the content and deletes the requested content from the cache when the request count value is greater than or equal to the first threshold value.

13. The dual caching apparatus of claim 11, wherein the cache policy execution unit positions the requested content in the first cache when the request count value is less than the first threshold value and greater than or equal to the second threshold value, and positions the requested content in the second cache when the request count value is less than the second threshold value.

14. The dual caching apparatus of claim 10, wherein the cache policy execution unit determines a cache replacement or determines whether to load the requested cache to the cache based on a comparison result between the request count value and the first threshold value, a state of the content cache, and a state of the second cache when there is no requested content in the content cache.

15. The dual caching apparatus of claim 14, wherein the cache policy execution unit prevents the requested content from being loaded to the cache when the request count value is greater than or equal to the first threshold value.

16. The dual caching apparatus of claim 14, wherein, when the request count value is less than the first threshold value and a content cache state is not a full state, the cache policy execution unit positions the requested content in the first cache when the request count value is greater than or equal to the second threshold value, and positions the requested content in the second cache when the request count value is less than the second threshold value.

17. The dual caching apparatus of claim 14, wherein, when the request count value is less than the first threshold value and the content cache state is a full state, the cache policy execution unit deletes at least some content of the second cache when the second cache is not empty, and deletes at least some content of the first cache when the second cache is empty.

18. The dual caching apparatus of claim 17, wherein the cache policy execution unit positions the requested content in the first cache when the request count value is greater than or equal to the second threshold value after at least some content of the first or second cache is deleted, and positions the requested content in the second cache when the request count value is less than the second threshold value.

19. A content server for executing a dual cache policy, comprising:
a dual caching apparatus including
a content cache unit configured to store a content cache separated into a first (premium) cache and a second (general) cache;
a pointer storage unit configured to store a pointer for variably separating the first and second caches;
a threshold value storage unit configured to store a first threshold value and a second threshold value that is less than the first threshold value; and
a cache policy execution unit configured to receive a request for content, manage a request count value for the content, and execute a cache policy based on results of comparing the request count value to the first threshold value and the second threshold value and whether there is requested content in the content cache.
